(19) United States
(12) Patent Application Publication
(10) Pub. No.: US 2010/0257268 A1
(43) Pub. Date: Oct. 7, 2010

(54) Methods, Systems, and Media for Controlling Access to Applications on Mobile Devices

(76) Inventors: Donald W. Landry, New York, NY (US); Tyler Faux, New York, NY (US); Joseph Gasperetti, New York, NY (US)

Correspondence Address: Byrne Poh LLP, 11 Broadway, Ste 865, New York, NY, 10004, US

(21) Appl. No.: 12/739,221

(22) PCT Filed: Nov. 26, 2008
(86) PCT No.: PCT/US08/84885

§ 371 Date: Apr. 22, 2010

Related U.S. Application Data
(60) Provisional application No. 60/990,172, filed on Nov. 26, 2007.

(51) Int. Cl. G06F 15/173

(52) U.S. Cl. 709/225

(57) ABSTRACT

Methods, systems, and media for controlling access to applications on mobile devices are provided. In accordance with some embodiments, a method for controlling access to mobile device applications is provided, the method comprising: receiving a presentation for distribution to a plurality of mobile devices, wherein at least one task is associated with the presentation and control information for controlling access to applications installed on each of the plurality of mobile devices is associated with the presentation; transmitting the presentation to the plurality of mobile devices; determining whether each of the plurality of mobile devices performed the at least one task associated with the presentation; and, in response to determining that a mobile device has not performed the at least one task, using the control information to disable at least one application installed on the mobile device.

### CROSS REFERENCE TO RELATED APPLICATION

This application claims the benefit of U.S. Provisional Patent Application No. 60/990,172, filed Nov. 26, 2007, which is hereby incorporated by reference herein in its entirety.

### TECHNICAL FIELD

The disclosed subject matter relates to methods, systems, and media for controlling access to applications on mobile devices.

### BACKGROUND

School administrators and instructors have the difficult task of keeping track of their students. This is particularly true for professors in medical schools, where it is estimated that medical students, medical interns, and resident physicians miss approximately thirty-five percent of their weekly lectures due to patient or other hospital commitments.

With recent advancements in communications network technologies, students have virtually unlimited access to information and media content that can be provided via networks such as the Internet. For example, distance learning has frequently been used by several institutions as an alternative to live classroom education. Distance learning can be provided via television broadcasts, teleconferences, webcasts, Internet chat rooms, and pre-recorded lectures available on Internet websites. However, while distance learning provides these students with greater flexibility, there are limited interactions between the students and the instructor. Moreover, even though these distance learning resources are made available to students, there is little incentive for these students to keep up with their studies.

### SUMMARY

Methods, systems, and media for controlling access to applications on mobile devices are provided. In accordance with some embodiments, a method for controlling access to mobile device applications is provided, the method comprising: receiving a presentation for distribution to a plurality of mobile devices, wherein at least one task is associated with the presentation and control information for controlling access to applications installed on each of the plurality of mobile devices is associated with the presentation; transmitting the presentation to the plurality of mobile devices; determining whether each of the plurality of mobile devices performed the at least one task associated with the presentation; and, in response to determining that a mobile device has not performed the at least one task, using the control information to disable at least one application installed on the mobile device.

In some embodiments, a system for controlling access to mobile device applications is provided, the system comprising: means for receiving a presentation for distribution to a plurality of mobile devices, wherein at least one task is associated with the presentation and control information for controlling access to applications installed on each of the plurality of mobile devices is associated with the presentation; means for transmitting the presentation to the plurality of mobile devices; means for determining whether each of the plurality of mobile devices performed the at least one task associated with the presentation; and, means for using the control information to disable at least one application installed on the mobile device in response to determining that a mobile device has not performed the at least one task.

In some embodiments, a system for controlling access to mobile device applications is provided, the system comprising: a processor that: receives a presentation for distribution to a plurality of mobile devices, wherein at least one task is associated with the presentation and control information for controlling access to applications installed on each of the plurality of mobile devices is associated with the presentation; transmits the presentation to the plurality of mobile devices; determines whether each of the plurality of mobile devices performed the at least one task associated with the presentation; and, in response to determining that a mobile device has not performed the at least one task, uses the control information to disable at least one application installed on the mobile device.

In some embodiments, a computer-readable medium storing computer-executable instructions that, when executed by a processor, causes the processor to perform a method for controlling access to mobile device applications is provided. The method comprises: receiving a presentation for distribution to a plurality of mobile devices, wherein at least one task is associated with the presentation and control information for controlling access to applications installed on each of the plurality of mobile devices is associated with the presentation; transmitting the presentation to the plurality of mobile devices; determining whether each of the plurality of mobile devices performed the at least one task associated with the presentation; and, in response to determining that a mobile device has not performed the at least one task, using the control information to disable at least one application installed on the mobile device.

### BRIEF DESCRIPTION OF THE DRAWINGS

FIG. 1 is a flow diagram showing the interconnections between various devices suitable for implementation of a mechanism that controls mobile device applications in accordance with some embodiments.

FIG. 2 is a diagram showing an example of a database structure that can be implemented in a database in accordance with some embodiments.

FIG. 3 is a diagram of a mechanism for selectively controlling access to one or more applications on mobile devices in accordance with some embodiments.

FIG. 4 is a diagram showing an example of an administrator display for allowing an administrator to create a presentation and/or assessment in accordance with some embodiments.

FIGS. 5 and 6 are diagrams showing an example of task displays that are presented to an administrator for creating a quiz that includes questions related to the presentation in accordance with some embodiments.

FIGS. 7, 8, and 9 are diagrams showing an example of a presentation in accordance with some embodiments.

FIGS. 10 and 11 are diagrams showing an example of a display for allowing users at mobile devices to responding to a presentation in accordance with some embodiments.

FIG. 12 is a diagram of a mechanism for determining whether a user using a mobile device is authorized to access an application installed on the mobile device in accordance with some embodiments.

### DETAILED DESCRIPTION

In accordance with various embodiments, methods, systems, and media can provide mechanisms through which access to any suitable application (e.g., a Web browser, an e-mail application, a short messaging service, a telephone service, a gaming application, a research application, a calendar application, an address book application, a task list application, an electronic notepad, a calculator application, an alarm clock application, an image display application, a video player, an audio player, an instant messaging application, etc.) can be controlled based at least upon a user of a mobile device performing certain tasks or activities.

For example, in some embodiments, an administrator at an administrator device can create a presentation and/or assessment that includes one or more tasks (e.g., watch the presentation, click through the slides in a presentation, answer one or more questions, etc.). The assessment allows the administrator to assess users at mobile devices to, for example, ensure that the users comprehended the material (e.g., users that missed the live class). The presentation and/or assessment can be uploaded to a server, where the server alerts one or more mobile devices that the presentation and/or assessment are available. The server can receive one or more indications relating to whether a mobile device accesses the presentation and/or assessment, whether a mobile device completes the tasks associated with the presentation and/or assessment, etc. If the tasks associated with the presentation and/or assessment include questions, a quiz, or any other suitable task that requests a response from a user at a mobile device, the server may collect the responses received from one or more of the mobile devices and transmit the responses to the administrator at the administrator device. In response to the indications and/or received responses, access to any suitable application of one or more of the mobile devices can be controlled.

These mechanisms can be used in a variety of applications. For example, a medical student can be restricted from accessing a Web browser or any other suitable application on a mobile device if the student does not review a presentation and/or answer certain questions relating to the presentation. In this way, such a student can be incentivized to perform the required task. In another example, a student can be restricted from sending text messages from a mobile device using a short messaging service (SMS) if the student does not review the slides contained in a presentation within a predetermined amount of time (e.g., twenty-four hours). Accordingly, these mechanisms provide an efficient transfer of information to users (e.g., lecture and/or other information to students) and administrators (e.g., assessment information to professors).

It should be noted that particular applications on the mobile device can be disallowed from being disabled or the disabling of particular applications can be bypassed and/or overridden. For example, in emergency situations or in an event satisfying other criteria (e.g., obtaining location information that positions the mobile device within a hospital), particular applications on the mobile device, such as the telephone service on the mobile device, can be bypassed.

In yet another example, these mechanisms can be used for continuing education courses (e.g., continuing medical education, continuing legal education, etc.). In response to registering a mobile device, the administrators or instructors of continuing education courses can continually or periodically test and/or assess the participants in the course. For example, in response to receiving a presentation and/or assessment on a mobile device, the user of the mobile device can be required to answer a particular number of questions correctly in order to receive credit for participating in the course.

In some embodiments, in exchange for being limited in what particular applications a user can access using a mobile device, the user can be provided with the mobile device at a lower cost than the market value for such a device or for free. In some embodiments, advertising or sponsorship presentations can be made to the user to subsidize some of the cost associated with the mobile device and/or related services. For example, an administrator or any other suitable user can partner with an advertiser (e.g., a pharmaceutical company) for providing advertisements on the mobile device. Such advertisements can be used to offset the costs of the mobile device and/or related services.

It should be noted that the mechanisms described herein can be implemented on any suitable mobile device or platform (e.g., a personal computer (PC), a wireless terminal, a portable telephone, a portable computer, a palmtop computer, a handheld personal computer (H/PC), a laptop computer, a personal digital assistant (PDA), a combined cellular phone and PDA, etc.) to provide such features.

It should also be noted that the application controlled on the mobile device can be any suitable application. For example, the mobile device application can be a Web browser, an e-mail application, a short messaging service, a telephone service, a gaming application, a research application, a medical reference application, a calendar application, an address book application, a task list application, an electronic notepad, a calculator application, an alarm clock application, an image display application, a video player application, an audio player application, an instant messaging application, etc.

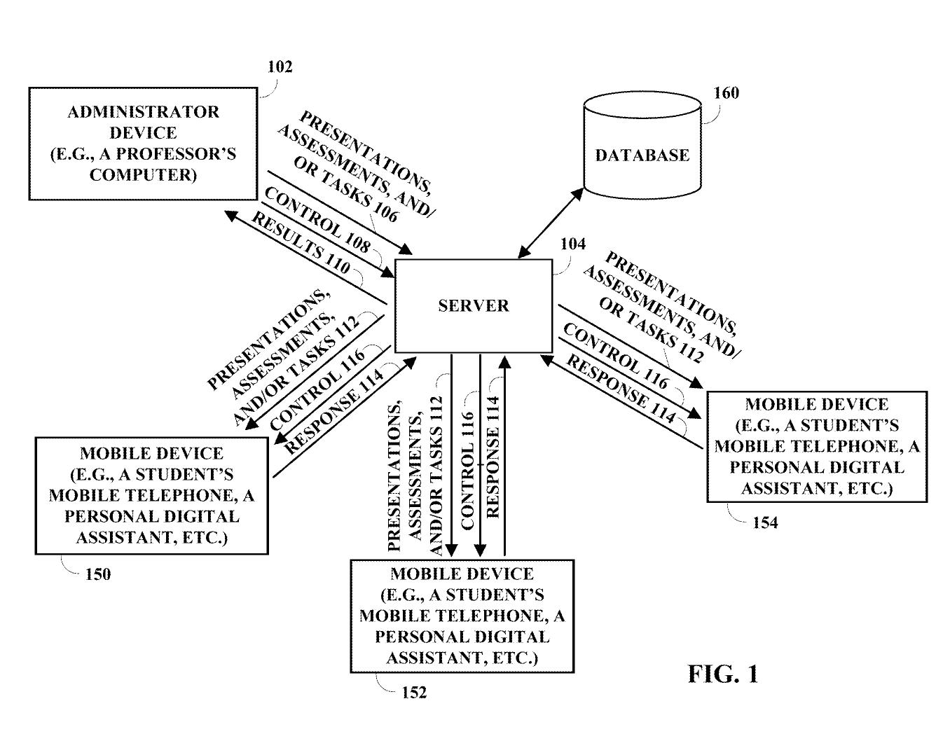

FIG. 1 is a flow diagram showing the interconnections between various devices—e.g., an administrator device 102, a server 104, mobile devices 150, 152, and 154, and a database 160—in accordance with some embodiments.

System 100 can include an administrator device 102. Administrator device 102 can be used to create and provide presentations, assessments, and/or tasks 106, control information 108, or any other suitable information to server 104.

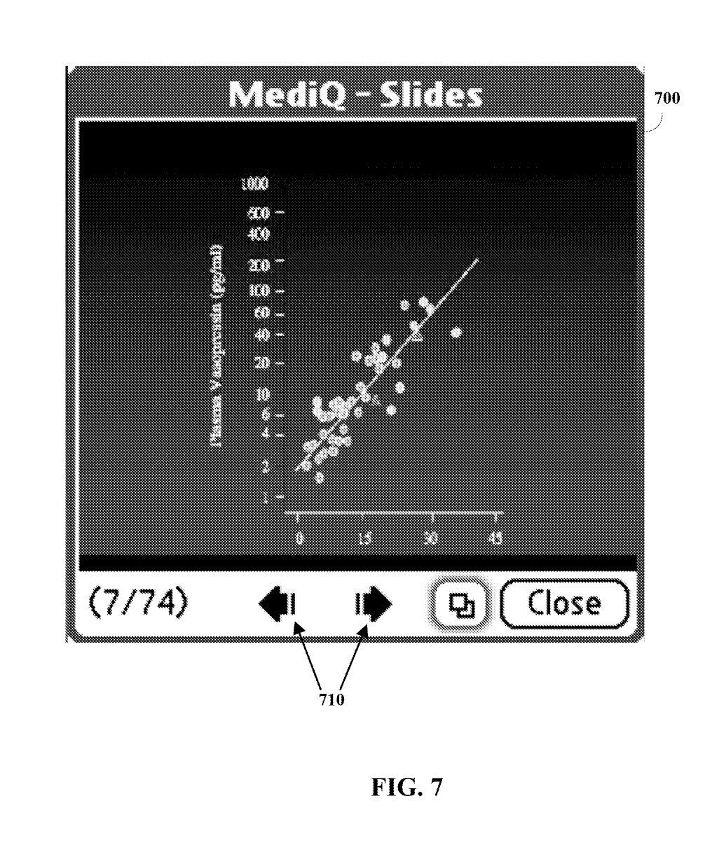

Presentations, assessments, and/or tasks 106 can include any suitable content, such as educational slides, audio segments (e.g., a lecture in MPEG-1 Audio Layer 3 (MP3) format), video clips (e.g., a podcast), texts, papers (e.g., an article in PDF format), animations, movies, etc. For example, FIGS. 7-9 provide illustrative examples of a slide 700 from a medical presentation and/or assessment. As shown, slide 700 provides a graph showing the relationship between plasma vasopressin and the percentage decrease in mean arterial pressure.

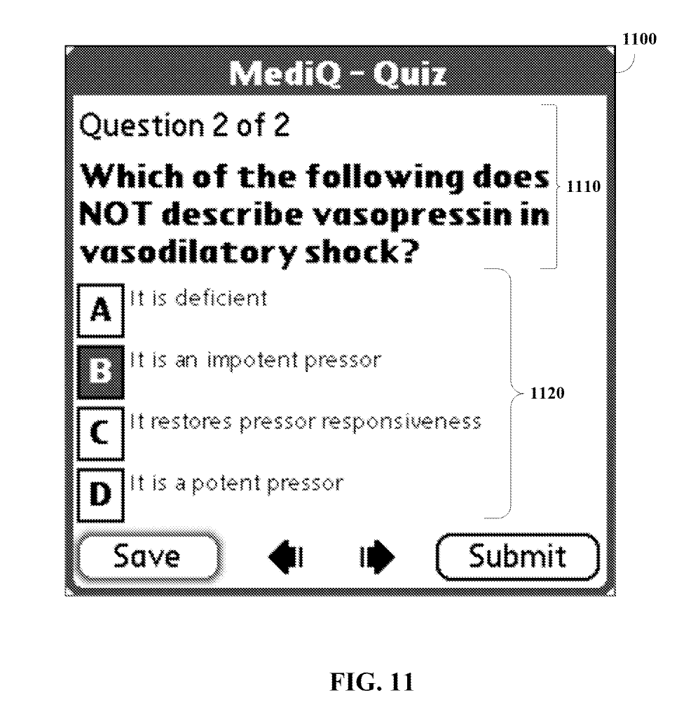

In some embodiments, an assessment and/or tasks can be associated with presentation 106. Tasks can include, for example, questions that can be provided as a portion of presentation and/or assessment 106, rules that users are required to view presentation 106 within twelve hours, etc. Questions can be any suitable types of questions, such as multiple choice questions, true or false questions, fill-in questions, essay questions, timed questions, etc. It should be noted that these questions can be used to determine whether a user of a mobile device comprehends certain subject matter or whether the user was paying attention during the presentation. For example, a question can prompt the user to enter a code that was presented during the presentation. In another example, a quiz including multiple questions can be provided to the user at the end of the presentation. For example, FIG. 11 provides an illustrative example of a question interface 1100 that provides a question associated with the presentation and/or assessment of FIG. 7. As shown, question interface 1100 provides a user of a mobile device with one or more questions 1110 and multiple answer options 1120.

In another example, tasks associated with presentation and/or assessment 106 can include requiring that the user of a mobile device access or review presentation and/or assessment 106 within a predetermined amount of time (e.g., twenty-four hours). In yet another example, tasks can include requiring that the user of a mobile device access or review a particular presentation and/or assessment before accessing another presentation and/or assessment (e.g., the next presentation in a lecture series).

Control information 108 can be any suitable information regarding a presentation, an assessment, a task, a question, results from the presentation and/or questions, application access instructions, rules, etc. For example, control information can indicate when a presentation is required to be viewed by before access to a mobile device application is restricted (e.g., if the presentation is not viewed by the user within twenty-four hours, the Web browser application of that mobile device is disabled). In another example, control information can indicate that one or more questions associated with a presentation are required to be answered by a user of a mobile device, that a quiz associated with a presentation is required to be submitted from the user to the administrator device 102, etc.

It should be noted that, in some embodiments, control information 108 can be associated with a particular presentation and/or assessment 106. For example, control information 108 can indicate that a particular presentation is required to be viewed before access to a mobile device application is restricted. Alternatively, control information 108 can also be associated with multiple presentations and/or assessments 106. For example, control information 108 can indicate that every presentation made available to users of mobile devices (e.g., students) is required to be viewed within twenty-four hours before access to a mobile device application on each of the mobile devices is restricted. In another example, control information 108 can indicate that, in response to not viewing one presentation within twelve hours, one mobile device application is disabled and, in response to not viewing another presentation within twenty-four hours, another mobile device application is disabled.

In some embodiments, control information 108 can indicate which applications on the mobile device are to be controlled. For example, administrator device 102 can use control information 108 to direct the server to disable the Web browser of a mobile device that does not perform certain tasks or activities. In another example, administrator device 102 can use control information 108 to direct the server to disable multiple applications (e.g., every gaming application, every media player application, a Web browser application and a text messaging application, etc.).

In some embodiments, control information 108 can be used to disable particular applications based on the degree of non-compliance of the mobile user. In one example, presentation 106 can include a question after every slide. In response to the user of a mobile device not responding to the first question, control information 108 can request that one particular application (e.g., the Web browser) be disabled. In response to the user of a mobile device not responding to the second question, control information can request that another application be disabled (e.g., the email application).

In some embodiments, control information 108 can direct the server to disable particular applications based on results 110 received from server 104. For example, control information 108 can indicate how many questions must be answered correctly, a particular score that a user must achieve on a quiz, and/or any other suitable number of indications (e.g., inactivity for twelve hours) before one or more mobile device applications are disabled.

It should be noted that control information 108 can be transmitted to server 104 at any suitable time. For example, in some embodiments, control information 108 is transmitted to server 104 as part of or simultaneously with presentation and/or assessment 106. In another example, control information 108 can be transmitted after receiving results 110 from server 104. In addition, control information 108 can be modified by an administrator at any suitable time. For example, in response to receiving an indication that a percentage of users have not accessed the presentation within twelve hours, the administrator can modify control information 108 to disable every mobile device application.

Alternatively, in some embodiments, control information 108 can be set to default control information. In the event administrator device 102 does not indicate and/or assign control information 108, server 104 can use a default setting for control information 108. For example, in response to not receiving control information 108 from administrator device 102, server 104 can automatically defer to default control information requesting that server 104 disable instant messaging applications and Web browsing applications on mobile devices that do not submit responses to questions associated with presentation and/or assessment 106 within a predetermined amount of time.

As described previously, results 110 can indicate the results of one or more users of mobile devices to presentations, assessments, and/or tasks 106. For example, results 110 can indicate whether, when, or how users responded to presentations, assessments, and/or tasks 106. As a more particular example, a user at a mobile device may have responded by taking and passing a quiz associated with presentation and/or assessment 106, a user at a mobile device may have responded by viewing a presentation on the mobile device (e.g., advancing through each slide in a presentation and/or assessment 106), a user at a mobile device may have responded by viewing a presentation on a personal computer or any other suitable platform, etc. In some embodiments, server 104 compiles responses 114 received from mobile devices 150, 152, and/or 154 into results 110 and transmits results 110 to administrator device 102.

In some embodiments, results 110 can include statistics collected or determined by server 104. For example, server 104 may receive responses (e.g., responses 114 from mobile devices 150, 152, and/or 154) and calculate statistics based on the received responses. As a more particular example, server 104 (or any other suitable device) can determine the percentage of users at mobile devices that accessed presentation and/or assessment 106. In response to receiving the statistics, administrator device 102 can use the statistics as feedback information for setting and/or revising control information 108. For example, while administrator device 102 originally transmitted control information 108 to disable Web browsing applications on mobile devices that do not view the presentation and/or assessment 106 after a particular amount of time, administrator device 102 can monitor the statistics to change control information 108 such that additional mobile device applications are disabled when a certain threshold is not met (e.g., 20% of students are not completing their assignments). Alternatively, administrator device 102 can use statistics and/or results to enable features that are currently not enabled on a mobile device. For example, in response to receiving statistics indicating that 100% of medical students have answered the questions associated with presentation and/or assessment 106 correctly, administrator device 102 can revise control information 108 to enable an annual subscription to a medical research application on each mobile device.

Referring back to FIG. 1, server 104 can be coupled to mobile devices 150, 152, and 154. As illustrated, presentations, assessments, and/or tasks 112 and/or control information 116 can be transmitted from server 104 to mobile devices 150, 152, and 154. In response to presentation, assessments, and/or tasks 112, each mobile device 150, 152, and/or 154 can transmit a response 114 to server 104. For example, each response 114 can indicate whether, when, and/or how a user at a mobile device responded to presentation, assessment, and/or task 112. Again, as a more particular example, a user at a mobile device may have responded by taking and passing a quiz associated with presentation and/or assessment 112, a user at a mobile device may have responded by viewing a presentation on the mobile device (e.g., advancing through each slide in presentation and/or assessment 112), a user at a mobile device may have responded by viewing presentation and/or assessment 112 on a personal computer or any other suitable platform, etc.

In some embodiments, presentations, assessments, and/or tasks 112 are a portion of presentations, assessments, and/or tasks 106 submitted by administrator device 102. For example, an administrator, professor, or any suitable user at administrator device 102 can create a presentation 106 that includes a presentation with a plurality of educational slides and a quiz with questions and the answers for each of the questions. Server 104 can transmit presentation 112 to mobile devices 150, 152, and 154 that includes the presentation with the plurality of educational slides and the quiz with the questions. In response, response 114 can indicate whether, when, and/or how a user at a mobile device responded to presentation 150 (e.g., whether the user responded to the questions in a timely fashion) and can include the user's answers to each of the questions in the quiz.

Alternatively, presentations, assessments, and/or tasks 112 are the same as presentations, assessments, and/or tasks 106 submitted by administrator device 102. For example, an administrator, professor, or any suitable user at administrator device 102 can create a lecture series or a plurality of presentations, where the server makes the lecture series available to a mobile user. In response, response 114 can indicate whether, when, and/or how a user at a mobile device responded to the lecture series.

Mobile devices 150, 152, and/or 154 can allow server 104 to control access to applications on mobile devices 150, 152, and 154 using any suitable approach. For example, server 104 can send a request to each mobile device 150, 152, and 154 requesting that server 104 be granted permission to control access to applications (e.g., Web browsers, email applications, etc.) on each mobile device. In another example, users at mobile device 150, 152, and/or 154 can access one or more Web pages (e.g., via any suitable encoding, such as HyperText Markup Language (HTML), Dynamic HyperText Markup Language (DHTML), Extensible Markup Language (XML), JavaServer Pages (JSP), Active Server Pages (ASP), Cold Fusion, or any other suitable approaches) and install a controller application on their mobile devices. In yet another example, in response to accessing presentations and/or assessments 110, a mobile device automatically agrees to allow server 104 to control access to applications on the mobile device.

In some embodiments, server 104 can scan through and/or analyze each mobile device 150, 152, and/or 154 to determine which applications are installed on each mobile device (e.g., Google Search, Facebook, Gmail, Blackberry Maps, etc.). In other embodiments, server 104 can retrieve a registry file from a mobile device that indicates which applications are installed on the mobile device. Alternatively, server 104 and/or administrator device 102 can request that a user at a mobile device indicate which applications are installed on the mobile device.

Although three mobile devices 150, 152, and 154 are illustrated in FIG. 1, this is only illustrative. Any suitable number of mobile devices can be used.

In most embodiments, the methods of the present application will be implemented on machines that are programmed according to the techniques described with respect to the embodiments for carrying out the functional features of the methods. Such machines include, but are not limited to, general purpose computers, special purpose computers, etc. For example, administrator device 102, server 104, and/or mobile devices 150, 152, and/or 154 can be any suitable digital processing device(s). Administrator device 102 and/or mobile devices 150, 152, and/or 154 can be a general purpose device, such as a personal computer, a laptop computer, a mainframe computer, a dumb terminal, a data display, an Internet browser, a personal digital assistant (PDA), a two-way pager, a wireless terminal, or a portable telephone, or a special purpose device, such as a server, a portable telephone, a multimedia device, etc. Server 104 can be any suitable server for executing the application, such as a processor, a computer, a data processing device, or a combination of such devices. For example, server 104 can be a general purpose device, such as a computer, or a special purpose device, such as a client, a server, a multimedia server, etc. Any of these general purpose or special purpose devices can include any suitable components such as a processor (which can be a microprocessor, a digital signal processor, a controller, etc.), memory, communication interfaces, display controllers, input devices, etc. It should be noted that any reference to a general purpose computer are meant to be directed to a device programmed as described herein.

As another example, the user can interact with the server and/or administrator device via e.g., a personal computer or over PDA, e.g., the Internet, an Intranet, etc. Either of these may be implemented as a distributed computer system rather than a single computer. Similarly, the communications link may be a dedicated link, a modem over a POTS line, the Internet and/or any other method of communicating between computers and/or users. Moreover, the processor could be controlled by a software program on one or more computer systems or processors, or could even be partially or wholly implemented in hardware.

It should also be noted that administrator device 102, server 104, and/or mobile devices 150, 152, and/or 154 1010 can be located at any suitable locations. In one embodiment, administrator device 102, server 104, and/or mobile devices 150, 152, and/or 154 can be located within an organization. Alternatively, administrator device 102, server 104, and/or mobile devices 150, 152, and/or 154 can be distributed between multiple organizations. For example, administrator device 102 and mobile devices 150, 152, and/or 154 (e.g., cellular telephones) can be remote from each other, and can be connected by one or more communications links to a communications network that is linked via a communications link to server 104. Communications links can be any suitable communications link suitable for communicating data between administrator device 102, server 104, and mobile devices 150, 152, and 154, such as network links, dial-up links, wireless links, hard-wired links, etc.

It should further be noted that, in some embodiments, administrator device 102 and server 104 can be combined.

Referring back to FIG. 1, in some embodiments, server 104 can be coupled to a database 160 or database 160 can be incorporated into server 104. Database 160 can be any suitable mechanism for retrieving and/or storing presentation, assessment, task, questions, answers, control information, statistics, mobile device information, administrator device information, user information, any/or any other suitable information. For example, database 160 can be a flat file database, a relational database (e.g., a structured query language (SQL) database), a hierarchical database, a database structure used for rapid delivery of data, a database structure that has been tuned for read-only delivery for data, a client-based cache, or any other suitable storage device.

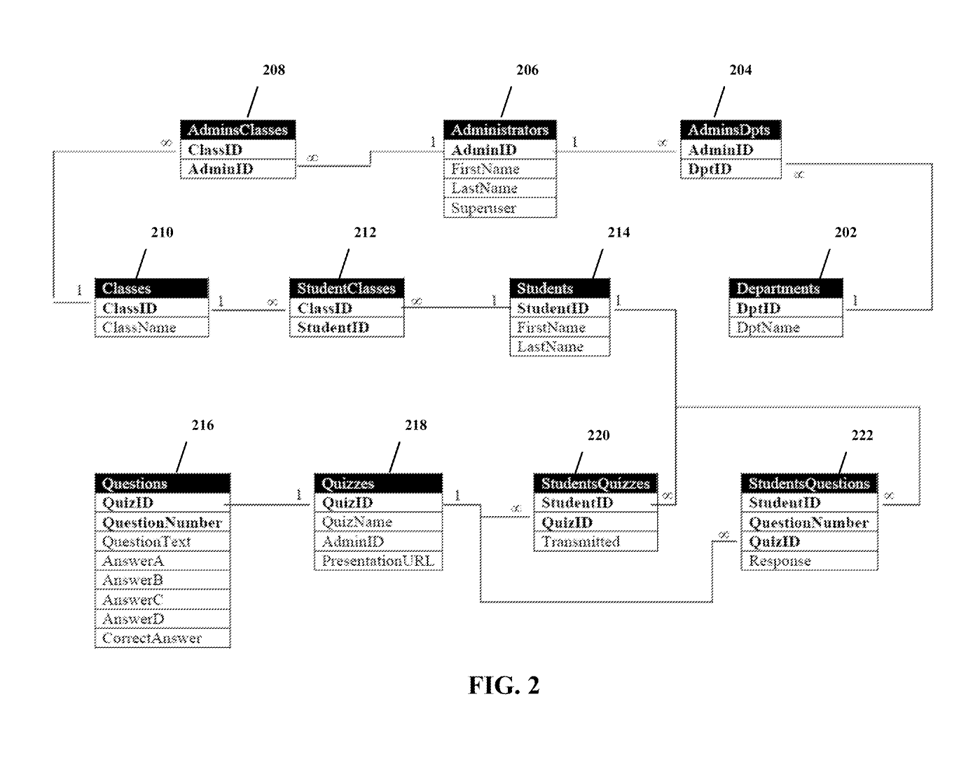

FIG. 2 shows an illustrative example of a database structure that can be implemented in database 160 of FIG. 1 and/or a database 160 incorporated into server 104. As shown in FIG. 2, tables 202, 204, 206, and 208 can be provided for storing information relating to administrators (e.g., professors, instructions, or any other suitable user at administrator device 102 of FIG. 1). For example, tables 202, 204, 206, and/or 208 can include personal information on an administrator, the classes taught by the administrator, the department information associated with the administrator, etc. As also shown in FIG. 2, tables 210, 212, and 214 can be provided for storing information relating to classes and students enrolled in each class. For example, tables 210, 212, and/or 214 can include mobile device information associated with each student, personal information associated with each student, class information associated with each student, etc. As also shown, tables 216, 218, 220, and 222 can be provided for storing information relating to questions, answers, tasks, quizzes, student-completed quizzes, student-completed answers, indications (e.g., indicators as to whether, when, and/or how a student responded to a presentation), etc. Any other suitable information can additionally or alternatively be stored in database 160.

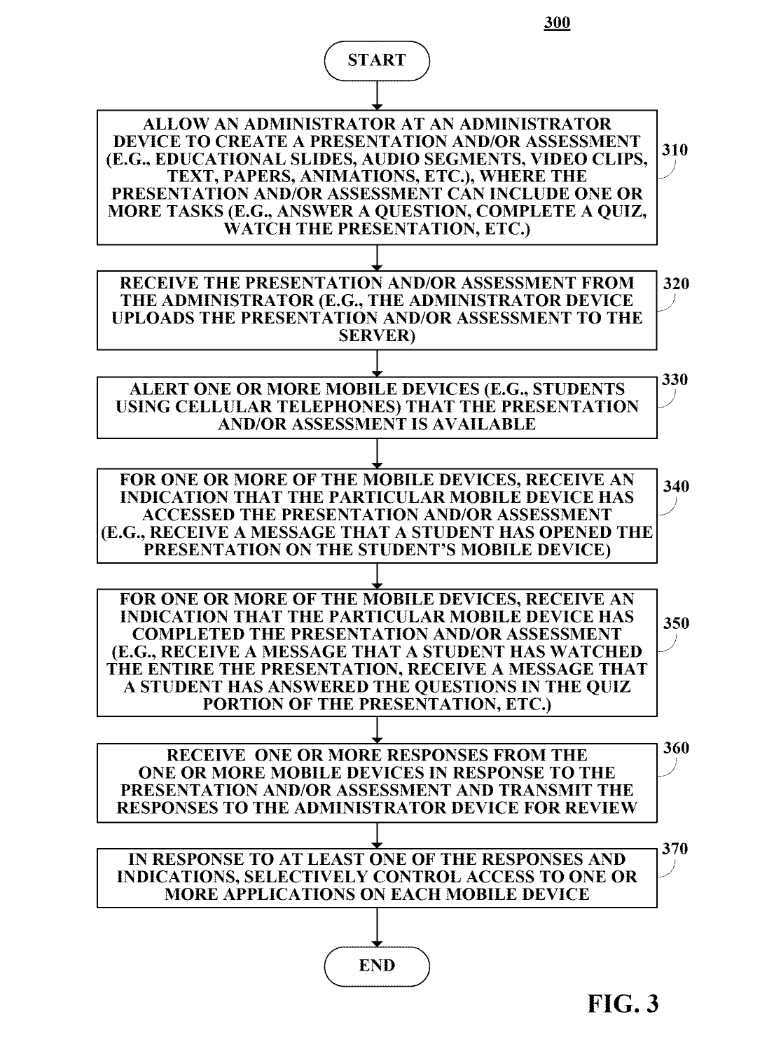

In accordance with some embodiments, applications on mobile devices can be selectively controlled using a process 300 as illustrated in FIG. 3. As shown, an administrator at an administrator device (e.g., administrator device 102 of FIG. 1) can create a presentation and/or assessment (e.g., presentation, assessment, and/or tasks 106 of FIG. 1) at 302. For example, the administrator can create a presentation that includes slides in Microsoft PowerPoint format, reference texts in portable document format (PDF), and audio clips that playback with particular slides in the presentation. The presentation and/or assessment can include one or more associated tasks, such as, for example, a requirement that users answer one or more questions related to the presentation, a requirement that users take and submit a quiz related to the presentation, a requirement that users access and review the presentation within a predetermined amount of time, etc.

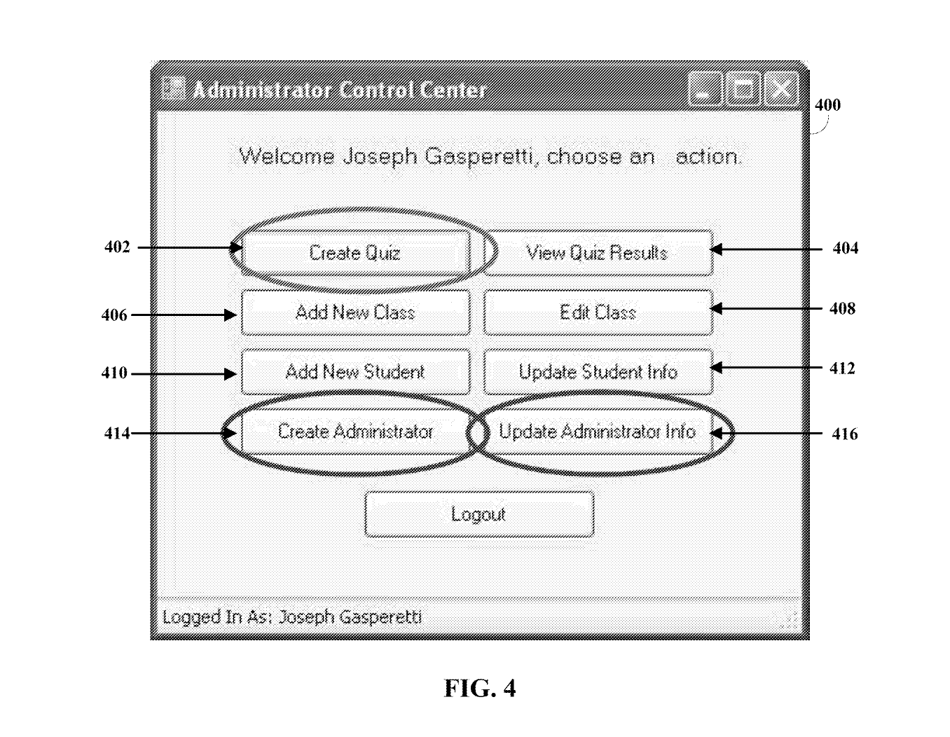

FIG. 4 provides an example of an administrator display 400 for allowing an administrator to create a presentation and/or assessment in accordance with some embodiments. As shown, administrator display 400 includes task buttons 402 and 404, class buttons 406 and 408, student buttons 410 and 412, and administrator buttons 414 and 416. It should be noted that although administrator display 400 (and other displays) show buttons, such as buttons 402-416, any suitable interface can be presented.

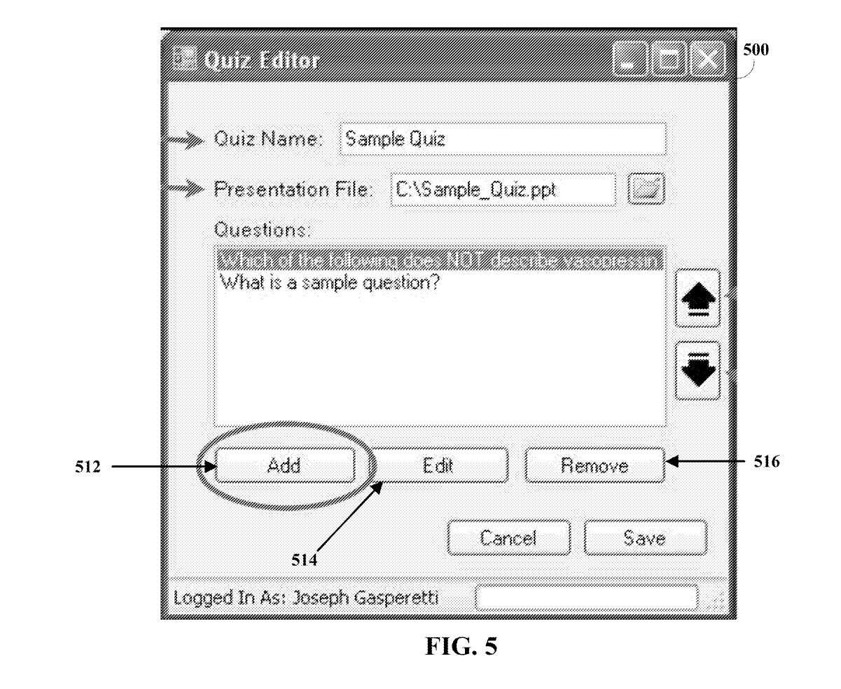

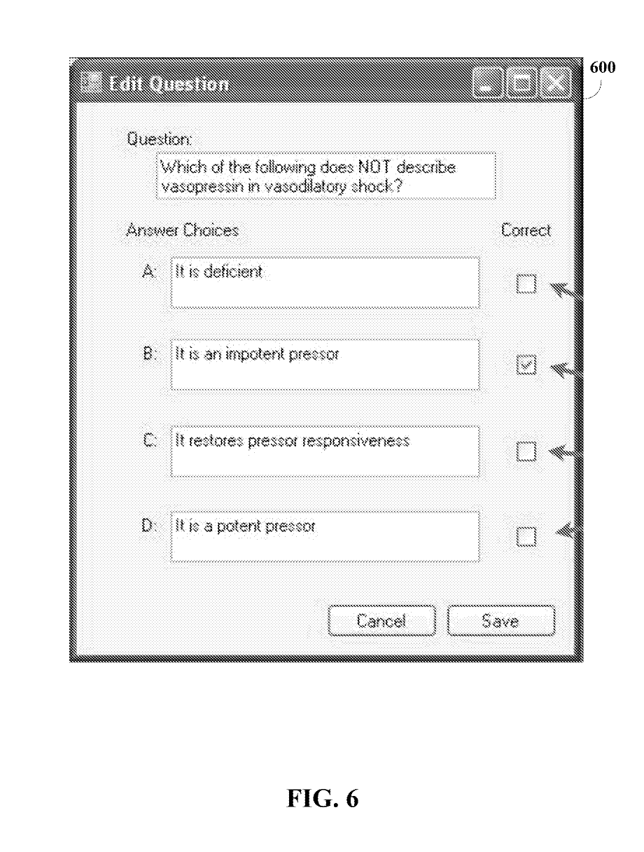

In response to an administrator selecting one of task buttons 402 and 404, a task associated with a presentation and/or assessment can be created and/or edited. For example, FIGS. 5 and 6 provide examples of task displays 500 and 600 that are presented to an administrator for creating a quiz that includes questions related to the presentation. As shown in FIG. 5, quiz editor display 500 allows a user, such as an administrator, to create and/or review a quiz associated with a presentation. In particular, the user is presented with an opportunity to add questions (e.g., button 512), edit a question (e.g., button 514), remove a question (e.g., button 516), etc. As shown in FIG. 6, in response to a user selecting a corresponding option in quiz editor display 500 of FIG. 5 (e.g., buttons 512 and 514), a question editor interface 600 can be presented that allows a user to add and/or edit a question (or any other suitable task) associated with the presentation. Using display 500, the text of a question associated with the presentation can be modified, the answer options associated with the question can be modified, and the correct answer for the question can be indicated.

Referring back to FIG. 4, in response to an administrator selecting one of class buttons 406 and 408, the administrator can create a new course, edit a class, edit a presentation previously uploaded for a class, create a new presentation, or any other suitable action relating to a course. For example, a professor can create a collection of presentations for a class, where the presentations are to be viewed in a particular order. In another example, a medical school professor can add new slides to a presentation in response to recent medical research.

In response to an administrator selecting one of student buttons 410 and 412, the administrator can add new students to a class (e.g., newly registered participants, students that transferred into the class, etc.), update student information (e.g., change personal information, change mobile device information associated with a student, change mobile device applications installed on a mobile device, etc.), assign particular students in a class to particular presentations, assign particular students in a class to particular questions, etc. For example, a professor can request that alerts to a presentation be transmitted to students that missed the live class.

As also shown in FIG. 4, administrator buttons 414 and 416 allow a user to add additional administrator users (e.g., users with permission to modify presentations, control applications on mobile devices, etc.), update administrator information, etc.

Referring back to FIG. 3, the server can receive the presentation and/or assessment from the administrator at 320. For example, in some embodiments, an administrator at an administrator device can upload the presentation and/or assessment, along with any associated tasks, to the server. The uploaded presentation and/or assessment and any associated tasks (e.g., quizzes, questions, answers, rules, etc.) can be stored in a database, such as database 160 of FIG. 1.

In response to uploading a presentation and/or assessment at 320, one or more mobile devices (e.g., students using cellular telephones) can be alerted that the presentation is available at 330. As described previously, the server or any other suitable device can provide particular portions of the presentation and/or assessment created by the administrator. For example, the server provides a user at a mobile device with the presentation and the quiz, but does not provide the user with the answers to the quiz or any control information specified by the administrator. In another example, an administrator can request that students receive different presentations and/or assessments based on the classes that each student missed.

It should be noted that any suitable alert can be provided to users at mobile devices using any suitable approach. For example, an email can be sent to the mobile devices, a short message service (SMS) message can be sent to the mobile devices, an alert tone can be generated, a message, icon, dialog box, and/or any other suitable visual indicator can be presented on a display of the mobile device, an indicator light on the mobile device can be turned-on or flashed, etc. In some embodiments, an email or any other suitable alert may be an electronic representative of a physical document, such as a letter, a paper contract, etc. The email then may be scanned to determine if a virus has been attached to the electronic representation. If the electronic representation is not contaminated, the electronic representation can be displayed on a display, printed on a printer, etc.

In some embodiments, the server can receive an indication that a mobile device has accessed the presentation and/or assessment at 340. For example, the student can access the presentation and/or assessment on the mobile device. In response to accessing the presentation and/or assessment, an indication (e.g., a message) can be sent to the server identifying the mobile device that accessed the presentation and/or assessment.

FIG. 7 provides an illustrative example of a slide 700 from a medical presentation created by an administrator in accordance with some embodiments. As shown, slide 700 provides a graph showing the relationship between plasma vasopressin and the percentage decrease in mean arterial pressure. Slide 700 and other slides in the presentation can be viewed using forward and backward buttons 710 (or any other suitable user interface). Alternatively, the user at a mobile device can use the keypad buttons on the mobile device (e.g., the left and right arrow buttons) to advance through the slides of a presentation.

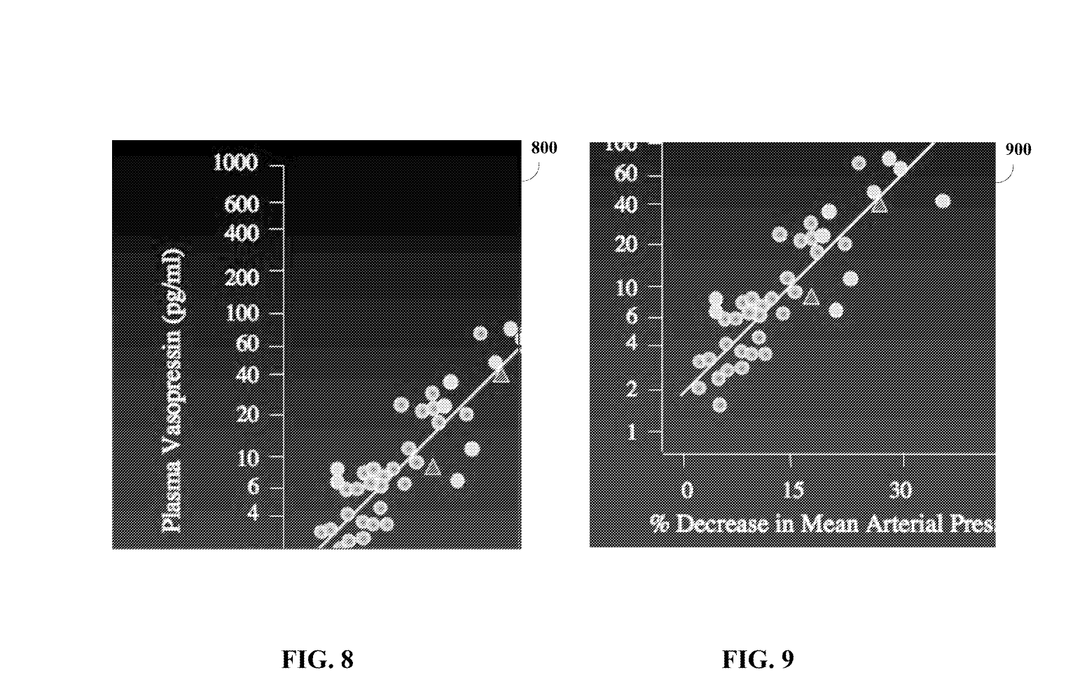

In some embodiments, a plurality of options corresponding to each slide or portion of a presentation can be presented to the user. For example, as shown in FIG. 8, the user at a mobile device is provided with a zoom option, where the user can zoom in or out of a portion of display 700. In another example, as shown in FIG. 9, the user at a mobile device is provided with a pan option that allows the user to move the location of the zoomed-in area displayed in FIG. 8. In yet another example, the user at a mobile device can be provided with any suitable feature, such as an option that rotates the content in a presentation, an option that allows the user to search for text within a presentation, etc.

Referring back to FIG. 3, using the indications received from one or more mobile devices, the server can monitor the number of mobile devices that access the presentation and/or assessment, whether the mobile devices accessed the presentation and/or assessment in a timely manner (e.g., within the designated time period), which mobile devices accessed the presentation and/or assessment (e.g., to disable applications for those mobile devices that did not access the presentation and/or assessment), when each mobile device accessed the presentation and/or assessment, etc.

In some embodiments, the server can generate statistics using this monitored information. For example, the server can collect, calculate, and present the administrator with statistics relating to the average time that users at mobile devices access the presentation and/or assessment, the percentage of users that access the presentation and/or assessment in a timely manner, etc.

In some embodiments, the server can receive an indication that a mobile device has completed the presentation and/or assessment at 350. As described previously, the presentation and/or assessment can include various tasks (e.g., take and pass a quiz, view the presentation on the mobile device, view the presentation on any computer within twenty-four hours from receiving the alert on the mobile device, etc.).

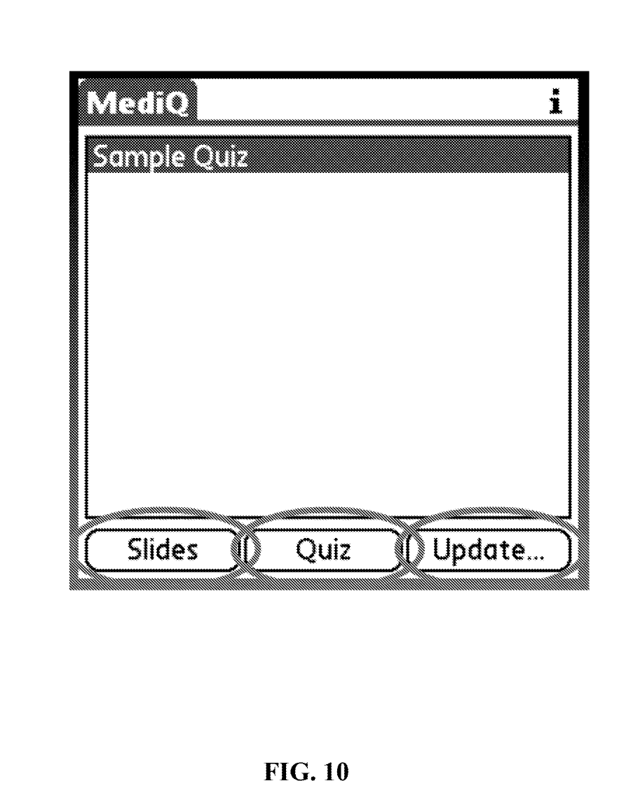

For example, as shown in FIGS. 10 and 11, users at mobile devices can be presented with a quiz relating to the presentation. As shown in FIG. 10, in addition to viewing the slides of the presentation or obtaining updates (e.g., new presentations, new tasks, etc.), the user can access a quiz for submission to the administrator. In response to the user selecting a “Quiz” button or any other suitable interface, the user can be presented with one or more questions associated with the presentation and/or assessment of FIG. 7. As shown, question interface 1100 provides a user of a mobile device with one or more questions 1110 and multiple answer options 1120. As also shown, the user of the mobile device can provide an answer (e.g., using the keypad, a stylus, or any other suitable user input approach), save the quiz (e.g., without submitting the quiz to the administrator), submit the selected answers to the questions in the quiz to the administrator, advance to other questions in the quiz, etc.

In some embodiments, the server can receive one or more responses from the mobile devices at 360. For example, after a student completes an assessment at 350, the answers provided by the student can be transmitted to the server. The server can compile the responses and provide the results to the administrator. It should be noted that the indications received at 330 and 340 can be provide as a part of the response from each mobile device.

At 370, in response to the responses, results, and/or indications, the administrator can selectively control access to one or more applications on each mobile device using the control information. For example, one or more mobile device applications can be disabled until the user complies with the tasks associated with the presentation.

As described previously, control information can be any suitable information regarding a presentation, an assessment, a task, a question, results from the presentation and/or questions, application access instructions, rules, etc. For example, control information can indicate when a presentation is required to be viewed by before access to a mobile device application is restricted (e.g., if the presentation is not viewed by the user within twenty-four hours, the Web browser application of that mobile device is disabled). In another example, control information can indicate that one or more questions associated with a presentation are required to be answered by a user of a mobile device, that a quiz associated with a presentation is required to be submitted from the user to the administrator device 102, etc.

The control information can indicate which applications on the mobile device are to be controlled. For example, an administrator can use control information to disable the Web browser of a mobile device that does not perform certain tasks or activities. In another example, an administrator can use control information to disable multiple applications (e.g., every gaming application, every media player application, every email application, etc.).

In some embodiments, a server or any other suitable entity can interpret the control information provided by the administrator. For example, such control information provided by an administrator can request that web browser applications are to be disabled in response to not performing certain tasks relating to a presentation. The server or any other suitable entity can determine which applications are installed on the mobile device and interpret the control information provided by the administrator to control the particular web browser application installed on the mobile device (e.g., a Google Search application).

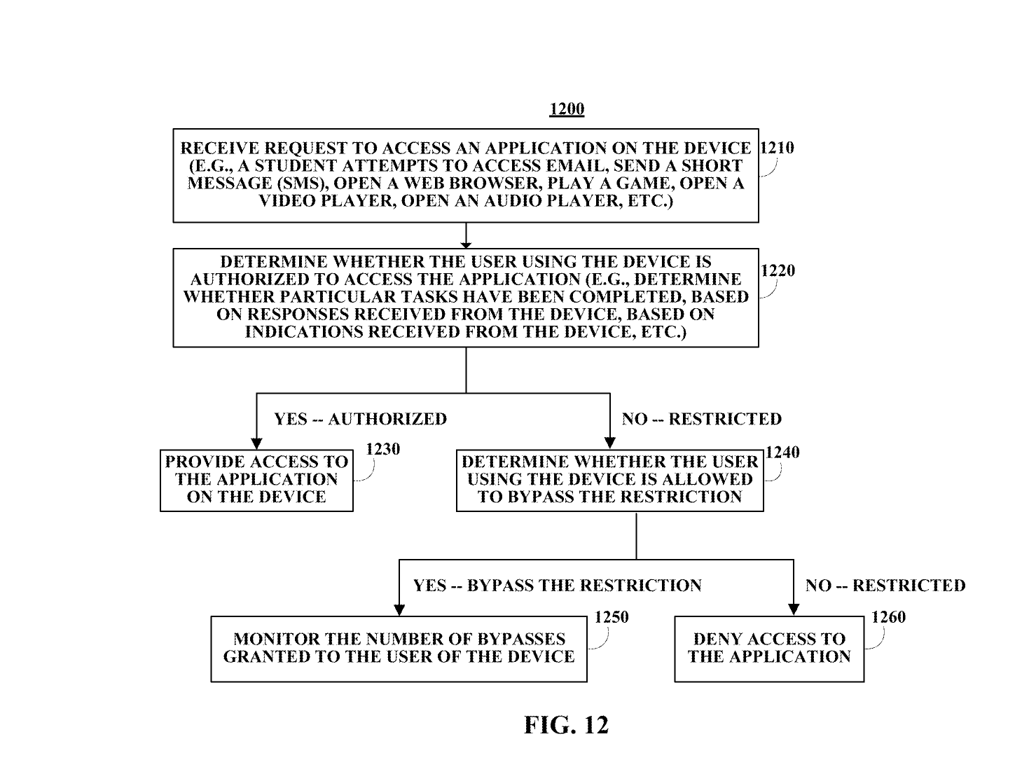

In accordance with some embodiments, in response to a user attempting to access an application on a mobile device, authorization can be determined using a process 1200 as illustrated in FIG. 12. As shown, at 1210, a request to access an application can be received. Such a request can be made, for example, by pressing a button, by receiving a phone call, by speaking a voice command, by removing a device from a holster or other storage container, by touching a touchpad or display, etc. The application can be a specific application (e.g., a medical research application) or a general application, such as an operating system.

A request to access an application can be detected and controlled in some embodiments by detecting application switching and launching functions in an operating system of a mobile device, and/or by modifying a jump table containing addresses for applications in memory. This detecting and launching and/or modifying can be part of the design for an operating system, or can be implemented as a patch to the design of the operating system. For example, in some embodiments, such capabilities may never have been envisioned by the designers of an operating system, although a patch to the operating system can be implemented to perform the detecting and launching and/or modifying.

At 1220, it can be determined whether the application can be accessed. Whether the application can be accessed can be based on any suitable criteria or criterion. For example, a user at a mobile device can be prevented from accessing one or more certain applications if a presentation and/or an assessment has not been completed in a certain period of time (e.g., twenty-four hours) since the user was first alerted to the presentation and/or assessment. As another example, a user at a mobile device can be prevented from accessing one or more certain applications if a certain number (e.g., two) of presentations and/or assessments have not been completed by the user.

In response to determining at 1220 that the application can be accessed, access to the application can be provided at 1230. For example, the application can be launched or initiated by the mobile device.

In response to determining at 1220 that the application cannot be accessed, it can then be determined whether the user (e.g., a student) can bypass the restriction on access to the application at 1240. This determination can be based on any suitable criteria or criterion. For example, a statistically timely or well-performing student can be permitted a certain number of bypasses. As another example, bypasses can be permitted at certain times (e.g., very late at night, holidays, etc.), places (e.g., in a hospital), etc. In this example, positioning and/or location information can be used to verify that the user of the mobile device was in a hospital during the time period in which the presentation was available for viewing.

In another example, the user can be permitted to bypass the application in response to determining that an urgent call or emergent situation has occurred. That is, in some embodiments, one or more applications on the mobile device are selectively disabled for non-emergent situations. Particular applications and/or features on the mobile device can be designated as applications that are to not be disabled (e.g., telephone services, email applications, etc.), while other applications and/or features of the mobile device can be disabled (e.g., web browsing applications, gaming applications, etc.) and the disabling can be bypassed in response to particular events (e.g., a medical emergency, being located in a hospital, an emergency situation, etc.).

In some embodiments, the administrator (or any other suitable user) can indicate which applications and/or features of the mobile device are not to be disabled. For example, as medical students are often needed at the hospital, applications generally used for patient care or any other hospital responsibilities (e.g., telephone service, text messaging applications, alarm applications, medical reference application, etc.) can be designated as not to be disabled.

In response to determining that the user is not allowed to bypass the restriction, the student can be denied access to the application at 1250. The student can be presented with a notification that the access is being denied and how the student can gain access to the application (e.g., complete the following tasks).

Alternatively, in response to determining that the user is allowed to bypass the restriction at 1240, the number of bypasses or any other suitable information relating to the bypasses can then be monitored at 1260.

Accordingly, methods, systems, and media for controlling access to applications on mobile devices are provided.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims that follow. Features of the disclosed embodiments can be combined and rearranged in various ways.

What is claimed is:

1. A method for controlling access to mobile device applications, the method comprising:
receiving a presentation for distribution to a plurality of mobile devices, wherein at least one task is associated with the presentation and control information for controlling access to applications installed on each of the plurality of mobile devices is associated with the presentation;
transmitting the presentation to the plurality of mobile devices;
determining whether each of the plurality of mobile devices performed the at least one task associated with the presentation; and
in response to determining that a mobile device has not performed the at least one task, using the control information to disable at least one application installed on the mobile device.

2. The method of claim 1, wherein the at least one task is one of: accessing the presentation within a given amount of time, reviewing the presentation within a given amount of time, submitting a quiz associated with the presentation, and submitting answers to one or more questions related to the presentation.

3. The method of claim 1, wherein the at least one application is one of: a Web browser, an e-mail application, a short messaging service, a telephone service, a gaming application, a research application, a calendar application, an address book application, a task list application, an electronic notepad, a calculator application, an alarm clock application, an image display application, a video player, an audio player, an instant messaging application, a mapping application, and a positioning application.

4. The method of claim 1, further comprising transmitting an alert to the plurality of mobile devices that the presentation is available.

5. The method of claim 1, further comprising determining which applications are installed on each of the plurality of mobile devices.

6. The method of claim 1, further comprising:
determining whether the mobile device is authorized to bypass the disabled application;
allowing the mobile device to initiate the disabled application in response to determining that the mobile device is authorized; and
tracking the number of times the mobile device attempts to bypass the disabled application.

7. The method of claim 1, further comprising receiving, from each mobile device, a response to the at least one task.

8. The method of claim 7, further comprising:
collecting the response received from each of the plurality of mobile devices;
calculating statistics based at least in part on the received response;
providing the calculated statistics to an administrator; and
receiving updated control information based at least in part on the calculated statistics.

9. The method of claim 1, wherein the at least one task includes a first task and a second task, further comprising disabling a first application in response to determining that the first task has not been performed the first task and disabling a second application in response to determining that the second task has not been performed.

10. A system for controlling access to mobile device applications, the system comprising:
means for receiving a presentation for distribution to a plurality of mobile devices, wherein at least one task is associated with the presentation and control information for controlling access to applications installed on each of the plurality of mobile devices is associated with the presentation;
means for transmitting the presentation to the plurality of mobile devices;
means for determining whether each of the plurality of mobile devices performed the at least one task associated with the presentation; and
means for using the control information to disable at least one application installed on the mobile device in response to determining that a mobile device has not performed the at least one task.

11. The system of claim 10, wherein the at least one task is one of: accessing the presentation within a given amount of time, reviewing the presentation within a given amount of time, submitting a quiz associated with the presentation, and submitting answers to one or more questions related to the presentation.

12. The system of claim 10, wherein the at least one application is one of: a Web browser, an e-mail application, a short messaging service, a telephone service, a gaming application, a research application, a calendar application, an address book application, a task list application, an electronic notepad, a calculator application, an alarm clock application, an image display application, a video player, an audio player, an instant messaging application, a mapping application, and a positioning application.

13. The system of claim 10, further comprising means for transmitting an alert to the plurality of mobile devices that the presentation is available.

14. The system of claim 10, further comprising means for determining which applications are installed on each of the plurality of mobile devices.

15. The system of claim 10, further comprising:
means for determining whether the mobile device is authorized to bypass the disabled application;
means for allowing the mobile device to initiate the disabled application in response to determining that the mobile device is authorized; and
means for tracking the number of times the mobile device attempts to bypass the disabled application.

16. The system of claim 10, further comprising means for receiving, from each mobile device, a response to the at least one task.

17. The system of claim 16, further comprising:
means for collecting the response received from each of the plurality of mobile devices;
means for calculating statistics based at least in part on the received response;
means for providing the calculated statistics to an administrator; and
means for receiving updated control information based at least in part on the calculated statistics.

18. The system of claim 10, wherein the at least one task includes a first task and a second task, further comprising means for disabling a first application in response to determining that the first task has not been performed and means for disabling a second application in response to determining that the second task has not been performed.

19. A system for controlling access to mobile device applications, the system comprising:
a processor that:
receives a presentation for distribution to a plurality of mobile devices, wherein at least one task is associated with the presentation and control information for controlling access to applications installed on each of the plurality of mobile devices is associated with the presentation;
transmits the presentation to the plurality of mobile devices;
determines whether each of the plurality of mobile devices performed the at least one task associated with the presentation; and
in response to determining that a mobile device has not performed the at least one task, uses the control information to disable at least one application installed on the mobile device.

20. The system of claim 19, wherein the at least one task is one of: accessing the presentation within a given amount of time, reviewing the presentation within a given amount of time, submitting a quiz associated with the presentation, and submitting answers to one or more questions related to the presentation.

21. The system of claim 19, wherein the at least one application is one of: a Web browser, an e-mail application, a short messaging service, a telephone service, a gaming application, a research application, a calendar application, an address book application, a task list application, an electronic notepad, a calculator application, an alarm clock application, an image display application, a video player, an audio player, an instant messaging application, a mapping application, and a positioning application.

22. The system of claim 19, wherein the processor is further configured to transmit an alert to the plurality of mobile devices that the presentation is available.

23. The system of claim 19, wherein the processor is further configured to determine which applications are installed on each of the plurality of mobile devices.

24. The system of claim 19, wherein the processor is further configured to:
determine whether the mobile device is authorized to bypass the disabled application;
allow the mobile device to initiate the disabled application in response to determining that the mobile device is authorized; and
track the number of times the mobile device attempts to bypass the disabled application.

25. The system of claim 19, wherein the processor is further configured to receive, from each mobile device, a response to the at least one task.

26. The system of claim 25, wherein the processor is further configured to:
collect the response received from each of the plurality of mobile devices;
calculate statistics based at least in part on the received response;
provide the calculated statistics to an administrator; and
receive updated control information based at least in part on the calculated statistics.

27. The system of claim 19, wherein the at least one task includes a first task and a second task, and wherein the processor is further configured to disable a first application in response to determining that the first task has not been performed and disable a second application in response to determining that the second task has not been performed.

28. A computer-readable medium storing computer-executable instructions that, when executed by a processor, causes the processor to perform a method for controlling access to mobile device applications, the method comprising:
receiving a presentation for distribution to a plurality of mobile devices, wherein at least one task is associated with the presentation and control information for controlling access to applications installed on each of the plurality of mobile devices is associated with the presentation;
transmitting the presentation to the plurality of mobile devices;
determining whether each of the plurality of mobile devices performed the at least one task associated with the presentation; and
in response to determining that a mobile device has not performed the at least one task, using the control information to disable at least one application installed on the mobile device.

29. The computer-readable medium of claim 28, wherein the at least one task is one of: accessing the presentation within a given amount of time, reviewing the presentation within a given amount of time, submitting a quiz associated with the presentation, and submitting answers to one or more questions related to the presentation.

30. The computer-readable medium of claim 28, wherein the at least one application is one of: a Web browser, an e-mail application, a short messaging service, a telephone service, a gaming application, a research application, a calendar application, an address book application, a task list application, an electronic notepad, a calculator application, an alarm clock application, an image display application, a video player, an audio player, an instant messaging application, a mapping application, and a positioning application.

31. The computer-readable medium of claim 28, wherein the method further comprises transmitting an alert to the plurality of mobile devices that the presentation is available.

32. The computer-readable medium of claim 28, wherein the method further comprises determining which applications are installed on each of the plurality of mobile devices.

33. The computer-readable medium of claim 28, wherein the method further comprises:
determining whether the mobile device is authorized to bypass the disabled application;
allowing the mobile device to initiate the disabled application in response to determining that the mobile device is authorized; and
tracking the number of times the mobile device attempts to bypass the disabled application.

34. The computer-readable medium of claim 28, wherein the method further comprises receiving, from each mobile device, a response to the at least one task.

35. The computer-readable medium of claim 34, wherein the method further comprises:
collecting the response received from each of the plurality of mobile devices;
calculating statistics based at least in part on the received response;
providing the calculated statistics to an administrator; and
receiving updated control information based at least in part on the calculated statistics.

36. The computer-readable medium of claim 28, wherein the at least one task includes a first task and a second task, and wherein the method further comprises disabling a first application in response to determining that the first task has not been performed the first task and disabling a second application in response to determining that the second task has not been performed.
